(19) United States
(12) Patent Application Publication
(10) Pub. No.: US 2022/0178701 A1
(43) Pub. Date: Jun. 9, 2022

(54) SYSTEMS AND METHODS FOR POSITIONING A TARGET SUBJECT

(71) Applicant: BEIJING VOYAGER TECHNOLOGY CO., LTD., Beijing (CN)

(72) Inventors: Baohua ZHU, Beijing (CN); Shengsheng HAN, Beijing (CN); Tingbo HOU, Mountain View, CA (US)

(73) Assignee: BEIJING VOYAGER TECHNOLOGY CO., LTD., Beijing (CN)

(21) Appl. No.: 17/651,912

(22) Filed: Feb. 22, 2022

Related U.S. Application Data
(63) Continuation of application No. PCT/CN2019/102566, filed on Aug. 26, 2019.

(51) Int. Cl. G01C 21/30; G06T 7/70; G06T 7/55; B60W 60/00

(52) U.S. Cl. CPC G01C 21/30; G06T 7/70; G06T 7/55; B60W 60/001; B60W 2556/60; G06T 2207/30244; G06T 2207/30252; B60W 2420/42; B60W 2420/52; G06T 2207/10028

(57) ABSTRACT

The present disclosure relates to systems and methods for determining a target position of a target subject. The method may include determining an initial position of a target subject in real-time. The method may also include determining a plurality of images indicative of a first environment associated with the initial position of the target subject. Further, the method may include determining a first map based on the plurality of images. The first map may include first map data indicative of the first environment associated with the initial position of the target subject. The method may also include determining a target position of the target subject based on the initial position, the first map, and a second map in real-time. The second map may include second map data indicative of a second environment corresponding to an area including the initial position of the target subject.

### CROSS-REFERENCE TO RELATED APPLICATIONS

This application is a continuation of International Patent Application No. PCT/CN2019/102566, filed on Aug. 26, 2019, the contents of which are hereby incorporated by reference.

### TECHNICAL FIELD

The present disclosure generally relates to systems and methods for positioning a target subject, and in particular, to systems and methods for positioning the target subject using real-time map data collected by positioning sensors and pre-generated high-definition map data.

### BACKGROUND

A Global Positioning System (GPS) can position a subject (e.g., a moving vehicle, an office building, etc.). The GPS normally provides the location of the subject in longitude and latitude without an attitude of the subject (e.g., a raw angle, a pitch angle, a roll angle). In some places (e.g., a tunnel), the GPS signal may be not strong enough to accurately position the subject passing through the tunnel. In order to solve the issues, a current platform may combine the GPS with other positioning sensors to position the subject, for example, an Inertial Measurement Unit (IMU). The IMU can provide the attitude of the subject. Further, when the intensity of the GPS signal is weak in some places (e.g., the tunnel), the IMU can still position the subject alone. However, in situations such as positioning and navigating an autonomous vehicle, the positioning accuracy of the GPS/IMU (e.g., at meter level, or at decimeter level) is not high enough. Since a positioning accuracy of a high-definition map can reach a centimeter level, the present disclosure uses the GPS/IMU and the high-definition map cooperatively to position the subject, thereby improving the positioning accuracy. Therefore, it is desirable to provide systems and methods for automatically positioning the target subject using the GPS/IMU and the high-definition map with higher accuracy.

### SUMMARY

In one aspect of the present disclosure, a system for determining a target position of a target subject is provided. The system may include at least one storage medium and at least one processor in communication with the at least one storage medium. The at least one storage medium may include a set of instructions. When executing the set of instructions, the at least one processor may be directed to determine, via a positioning device, an initial position of a target subject in real-time; determine, via a plurality of image capturing devices, a plurality of images indicative of a first environment associated with the initial position of the target subject; determine a first map based on the plurality of images, wherein the first map may include first map data indicative of the first environment associated with the initial position of the target subject; and determine a target position of the target subject based on the initial position, the first map, and a second map in real-time, wherein the second map may be predetermined based on Lidar, and the second map may include second map data indicative of a second environment corresponding to an area including the initial position of the target subject.

In some embodiments, the positioning device may include a Global Positioning System (GPS) and an Inertial Measurement Unit (IMU).

In some embodiments, the GPS and the IMU may be respectively mounted on the target subject.

In some embodiments, the initial position may include a location of the target subject and an attitude of the target subject.

In some embodiments, the plurality of image capturing devices may include at least one depth camera.

In some embodiments, the at least one depth camera may be respectively mounted on the target subject.

In some embodiments, wherein to determine a first map based on the plurality of images, the at least one processor may be directed to: determine a first position of each of the plurality of image capturing devices; and determine the first map by combining the plurality of images based on first positions of the plurality of image capturing devices.

In some embodiments, wherein to determine the first map by combining the plurality of images based on the position of each of the plurality of image capturing devices, the at least one processor may be directed to: obtain a point cloud represented by each of the plurality of images; transform the point clouds into a combined point cloud based on the positions of the plurality of image capturing devices; and determine the first map based on the combined point cloud.

In some embodiments, wherein to determine the target position of the target subject based on the initial position, the first map, and a second map in real-time, the at least one processor may be directed to: determine at least a portion of the second map based on the initial position of the target subject, wherein the at least a portion of the second map may include at least a portion of the second map data corresponding to a sub area including the initial position of the target subject within the area; and determine the target position by comparing the first map data to the at least a portion of the second map data.

In some embodiments, wherein to determine the target position by comparing the first map data to the at least a portion of the second map data, the at least one processor may be directed to: determine a match degree between map data of each position on the at least a portion of the second map and map data of the first map; and designate a position on the at least a portion of the second map with a highest match degree as the target position.

In some embodiments, the match degree may represent by a Normalised Information Distance (NID) or Mutual Information (MI).

In some embodiments, the target subject may include an autonomous vehicle.

In some embodiments, the at least one processor may be directed to: transmit a message to a terminal, directing the terminal to display the target position of the target subject on a user interface of the terminal in real-time.

In some embodiments, wherein the at least one processor may be directed to: provide a navigation service to the target subject based on the target position of the target subject in real-time.

In another aspect of the present disclosure, a method for determining a target position of a target subject is provided. The method may be implemented on a computing device having at least one processor, at least one storage medium, and a communication platform connected to a network. The method may include determining, via a positioning device, an initial position of a target subject in real-time; determining, via a plurality of image capturing devices, a plurality of images indicative of a first environment associated with the initial position of the target subject; determining a first map based on the plurality of images, wherein the first map may include first map data indicative of the first environment associated with the initial position of the target subject; and determining a target position of the target subject based on the initial position, the first map, and a second map in real-time, wherein the second map may be predetermined based on Lidar, and the second map may include second map data indicative of a second environment corresponding to an area including the initial position of the target subject.

In some embodiments, the positioning device may include a Global Positioning System (GPS) and an Inertial Measurement Unit (IMU).

In some embodiments, the GPS and the IMU may be respectively mounted on the target subject.

In some embodiments, the initial position may include a location of the target subject and an attitude of the target subject.

In some embodiments, the plurality of image capturing devices may include at least one depth camera.

In some embodiments, the at least one depth camera may be respectively mounted on the target subject.

In some embodiments, wherein the determining a first map based on the plurality of images may include: determining a first position of each of the plurality of image capturing devices; and determining the first map by combining the plurality of images based on first positions of the plurality of image capturing devices.

In some embodiments, wherein the determining the first map by combining the plurality of images based on the position of each of the plurality of image capturing devices may include: obtaining a point cloud represented by each of the plurality of images; transforming the point clouds into a combined point cloud based on the positions of the plurality of image capturing devices; and determining the first map based on the combined point cloud.

In some embodiments, wherein the determining the target position of the target subject based on the initial position, the first map, and a second map in real-time may include: determining at least a portion of the second map based on the initial position of the target subject, wherein the at least a portion of the second map may include at least a portion of the second map data corresponding to a sub area including the initial position of the target subject within the area; and determining the target position by comparing the first map data to the at least a portion of the second map data.

In some embodiments, wherein the determining the target position by comparing the first map data to the at least a portion of the second map data may include: determining a match degree between map data of each position on the at least a portion of the second map and map data of the first map; and designating a position on the at least a portion of the second map with a highest match degree as the target position.

In some embodiments, wherein the match degree may represent by a Normalised Information Distance (NID) or Mutual Information (MI).

In some embodiments, wherein the target subject may include an autonomous vehicle.

In some embodiments, the method may further include: transmitting a message to a terminal, directing the terminal to display the target position of the target subject on a user interface of the terminal in real-time.

In some embodiments, the method may also include: providing a navigation service to the target subject based on the target position of the target subject in real-time.

In another aspect of the present disclosure, a non-transitory computer readable medium for determining a target position of a target subject is provided. The non-transitory computer readable medium, including executable instructions that, when executed by at least one processor, may direct the at least one processor to perform a method. The method may include determining, via a positioning device, an initial position of a target subject in real-time; determining, via a plurality of image capturing devices, a plurality of images indicative of a first environment associated with the initial position of the target subject; determining a first map based on the plurality of images, wherein the first map may include first map data indicative of the first environment associated with the initial position of the target subject; and determining a target position of the target subject based on the initial position, the first map, and a second map in real-time, wherein the second map may be predetermined based on Lidar, and the second map may include second map data indicative of a second environment corresponding to an area including the initial position of the target subject.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary positioning system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing engine according to some embodiments of the present disclosure;

FIG. 5 is a flowchart illustrating an exemplary process for determining a target position of a target subject according to some embodiments of the present disclosure;

FIG. 6 is a flowchart illustrating an exemplary process for determining a first map based on a plurality of images according to some embodiments of the present disclosure; and

FIG. 7 is a flowchart illustrating an exemplary process for determining a target position of a target subject based on an initial position of the target subject, a first map and a second map according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for determining a target position of a target subject in real-time. The system may determine an initial position of the target subject in real-time via a positioning device (e.g., a GPS/IMU). The system may also determine a first map including first map data indicative of a first environment associated with the initial position of the target subject in real-time. Specifically, the system may determine the first map based on a plurality of images associated with the first environment via a plurality of image capturing devices. Further, the plurality of image capturing devices may include at least one depth camera. In addition, the system may predetermine a high-definition map including map data indicative of a second environment corresponding to an area including the initial position of the target subject. The system may determine the target position of the target subject by matching the first map and the high-definition map based on the initial position.

According to the present disclosure, since the positioning accuracy of the high-definition map is higher than the positioning accuracy of the GPS/IMU, the positioning accuracy achieved by combining the GPS/IMU and the high-definition map may be improved comparing to a positioning platform that only uses the GPS/IMU.

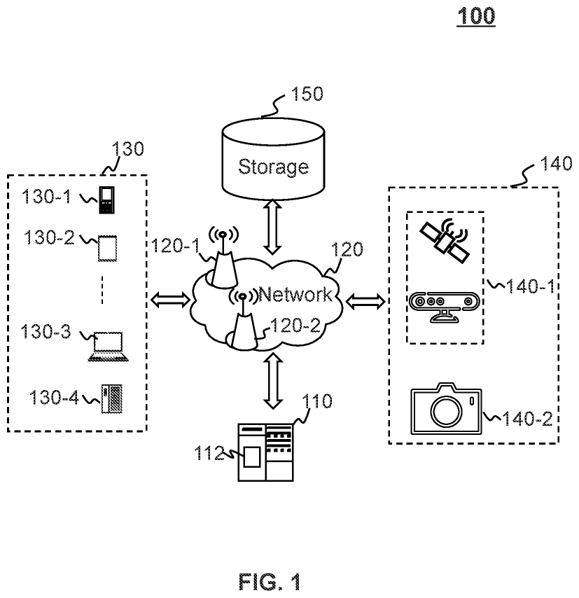

FIG. 1 is a schematic diagram illustrating an exemplary positioning system according to some embodiments of the present disclosure. The positioning system 100 may include a server 110, a network 120, a terminal device 130, a positioning engine 140, and a storage 150.

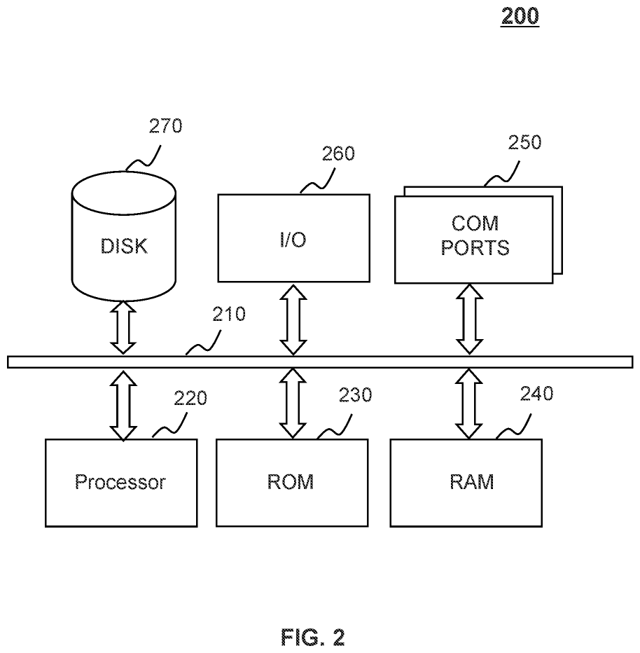

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the terminal device 130, the positioning engine 140, and/or the storage 150 via the network 120. As another example, the server 110 may be directly connected to the terminal device 130, the positioning engine 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2.

In some embodiments, the server 110 may include a processing engine 112. The processing engine 112 may process information and/or data to perform one or more functions described in the present disclosure. For example, the processing engine 112 may determine a first map based on a plurality of images indicative of a first environment associated with a position of a subject (e.g., a vehicle). In some embodiments, the processing engine 112 may include one or more processing engines (e.g., single-core processing engine(s) or multi-core processor(s)). The processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the positioning system 100 (e.g., the server 110, the terminal device 130, the positioning engine 140, or the storage 150) may transmit information and/or data to other component(s) of the positioning system 100 via the network 120. For example, the server 110 may obtain a plurality of images indicative of a first environment associated with a position of a subject (e.g., a vehicle) from the positioning engine 140 via the network 120. In some embodiments, the network 120 may be any type of wired or wireless network, or any combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the positioning system 100 may be connected to the network 120 to exchange data and/or information.

In some embodiments, the terminal device 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include an onboard computer, an onboard television, etc.

In some embodiments, the terminal device 130 may communicate with other components (e.g., the server 110, the positioning engine 140, the storage 150) of the positioning system 100. For example, the server 110 may transmit a target position of a target subject to the terminal device 130. The terminal device 130 may display the target position on a user interface (not shown in FIG. 1) of the terminal device 130. As another example, the terminal device 130 may transmit an instruction and control the server 110 to perform the instruction.

As shown in FIG. 1, the positioning engine 112 may at least include a positioning device 140-1 and a plurality of image capturing devices 140-2. The positioning device 140-1 may be mounted and/or fixed on the target subject. The positioning device 140-1 may determine position data of the target subject. The positioning data may include a location corresponding to the target subject and an attitude corresponding to the target subject. The location may refer to an absolute location of the target subject in a spatial space (e.g., the world) denoted by longitude and latitude information. The attitude may refer to an orientation of the target subject with respect to an inertial frame of reference such as a horizontal plane, a vertical plane, a plane of a motion of the target subject or another entity such as nearby objects. The attitude may include a raw angle of the target subject, a pitch angle of the target subject, a roll angle of the target subject, etc.

In some embodiments, the positioning device 140-1 may include different types of positioning sensors (e.g., two types of positioning sensors as shown in FIG. 1). The different types of positioning sensors may be respectively mounted and/or fixed on the target subject. In some embodiments, one or more positioning sensors may be integrated into the target subject. In some embodiments, the positioning device 140-1 may include a first positioning sensor that can determine an absolute location of the target subject and a second positioning sensor that can determine an attitude of the target subject. Merely by way of example, the first positioning sensor may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. The second positioning sensor may include an Inertial Measurement Unit (IMU). In some embodiments, the IMU may include at least one motion sensor and at least one rotation sensor. The at least one motion sensor may determine a linear accelerated velocity of the target subject, and the at least one rotation sensor may determine an angular velocity of the target subject. The IMU may determine the attitude of the target subject based on the linear accelerated velocity and the angular velocity. However, an error in determining the attitude of the target subject based on the IMU may exist, i.e., the attitude of the target subject determined based on the IMU may be not accurate, the IMU may be combined with another positioning sensor (e.g., the GPS) to accurately determine the attitude of the target subject. For illustration purpose, the IMU may include a Platform Inertial Measurement Unit (PIMU), a Strapdown Inertial Measurement Unit (SIMU), etc.

For illustration purpose, the positioning device 140-1 may include the GPS and the IMU (also referred to as “GPS/IMU”). The GPS and the IMU may be respectively mounted and/or fixed on the target subject. In some embodiments, the GPS and/or the IMU may be integrated to the target subject. The GPS may determine the location corresponding to the target subject and the IMU may determine the attitude corresponding to the target subject.

In some embodiments, each of the plurality of image capturing devices 140-2 may be mounted on the target subject. The plurality of image capturing devices 140-2 may respectively capture image data. In some embodiments, the plurality of image capturing devices may include at least one depth camera. The image data may include distance information and pixel information of each point associated with the first environment. The distance information of a point may represent a distance of the point from a viewing point (e.g., a point at which the image is captured). The pixel information may represent a gray value of the point or an intensity of light received by the point.

The storage 150 may store data and/or instructions. In some embodiments, the storage 150 may store data obtained from the server 110, the terminal device 130 and/or the positioning engine 140. In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the positioning system 100 (e.g., the server 110, the terminal device 130, the positioning engine 140). One or more components of the positioning system 100 may access the data and/or instructions stored in the storage 150 via the network 120. In some embodiments, the storage 150 may be directly connected to or communicate with one or more components of the positioning system 100 (e.g., the server 110, the terminal device 130, the positioning engine 140). In some embodiments, the storage 150 may be part of the server 110.

One of ordinary skill in the art would understand that when an element (or component) of the positioning system 100 performs, the element may perform through electrical signals and/or electromagnetic signals. For example, when the terminal device 130 transmits out an instruction to the server 110, a processor of the terminal device 130 may generate an electrical signal encoding the request. The processor of the terminal device 130 may then transmit the electrical signal to an output port. If the terminal device 130 communicates with the server 110 via a wired network, the output port may be physically connected to a cable, which further may transmit the electrical signal to an input port of the server 110. If the terminal device 130 communicates with the server 110 via a wireless network, the output port of the terminal device 130 may be one or more antennas, which convert the electrical signal to electromagnetic signal. Within an electronic device, such as the terminal device 130, the positioning engine 140, and/or the server 110, when a processor thereof processes an instruction, transmits out an instruction, and/or performs an action, the instruction and/or action is conducted via electrical signals. For example, when the processor retrieves or saves data from a storage medium (e.g., the storage 150), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device 200 according to some embodiments of the present disclosure. In some embodiments, the server 110, and/or the terminal device 130 may be implemented on the computing device 200. For example, the processing engine 112 may be implemented on the computing device 200 and configured to perform functions of the processing engine 112 disclosed in this disclosure.

The computing device 200 may be used to implement any component of the positioning system 100 as described herein. For example, the processing engine 112 may be implemented on the computing device 200, via its hardware, software program, firmware, or a combination thereof. Although only one such computer is shown, for convenience, the computer functions as described herein may be implemented in a distributed fashion on a number of similar platforms to distribute the processing load.

The computing device 200, for example, may include COM ports 250 connected to and from a network connected thereto to facilitate data communications. The computing device 200 may also include a processor 220, in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, and a read only memory (ROM) 230, or a random access memory (RAM) 240, for various data files to be processed and/or transmitted by the computing device. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

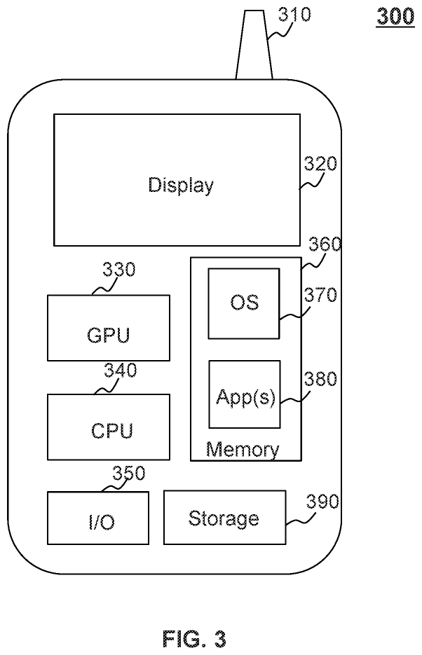

FIG. 3 is a schematic diagram illustrating exemplary hardware and/or software components of a mobile device 300 on which the terminal device 130 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information from the positioning system 100. User interactions with the information stream may be achieved via the I/O 350 and provided to the processing engine 112 and/or other components of the positioning system 100 via the network 120.

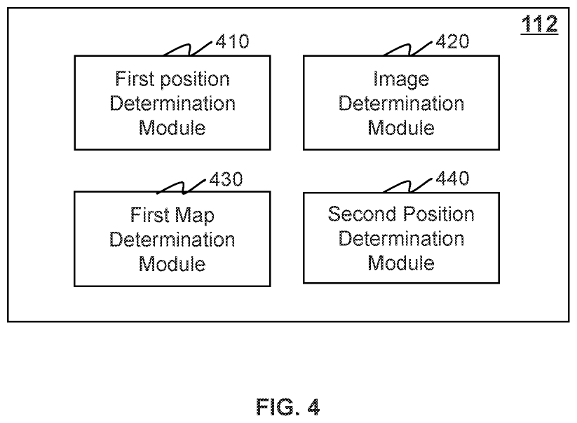

FIG. 4 is a block diagram illustrating an exemplary processing engine according to some embodiments of the present disclosure. The processing engine 112 may include a first position determination module 410, an image determination module 420, a first map determination module 430, and a second position determination module 440.

The first position determination module 410 may be configured to determine, via a positioning device (e.g., the positioning device 140-1), an initial position of a target subject in real-time. As used herein, the target subject may be any subject that needs to be positioned. As used herein, the initial position of the target subject may refer to a position corresponding to a target point of the target subject. In some embodiments, the first positioning module 410 may predetermine similar points (e.g., centers) as target points for different target subjects. In some embodiments, the first positioning module 410 may predetermine different points as target points for different target subjects. Merely by way of example, the target point may include a center of gravity of the target subject, a point where a positioning device (e.g., the positioning device 140-1) is mounted on the target subject, a point where an image capturing device (e.g., the image capturing device 140-2) is mounted on the target subject, etc.

In some embodiments, the first positioning determination module 410 may determine the initial position based on first position data determined by the positioning device, and a relation associated with the target point and a first point where the positioning device is mounted on the target subject. In some embodiments, the first positioning determination module 410 may determine the initial position by converting the first position according to a relation associated with the first point and the target point. Specifically, the first positioning determination module 410 may determine a converting matrix based on the relation associated with the first point and the target point. The first positioning determination module 410 may determine the converting matrix based on a translation associated with the first point and the target point and a rotation associated with the first point and the target point.

As used herein, the first positioning data may include a location corresponding to the first point and an attitude corresponding to the first point. The location may refer to an absolute location of a point (e.g., the first point) in a spatial space (e.g., the world) denoted by longitude and latitude information, and the absolute location may represent a geographic location of the point in the spatial space, i.e., longitude and latitude. The attitude may refer to an orientation of a point (e.g., the first point) with respect to an inertial frame of reference such as a horizontal plane, a vertical plane, a plane of a motion of the target subject or another entity such as nearby objects. The attitude corresponding to the first point may include a raw angle of the first point, a pitch angle of the first point, a roll angle of the first point, etc. Accordingly, the initial position of the target subject (i.e., the target point) may include an initial location of the target subject (i.e., the target point) and an initial attitude of the target subject (i.e., the target point). The initial location may refer to an absolute location of the target subject in the spatial space i.e., longitude and latitude. The initial attitude may refer to an orientation of the target subject with respect to an inertial frame of reference such as a horizontal plane, a vertical plane, a plane of a motion of the target subject or another entity such as nearby objects.

The image determination module 420 may be configured to determine, via a plurality of image capturing devices, a plurality of images indicative of a first environment associated with the initial position of the target subject. As used herein, the first environment may refer to an environment where the target subject is captured at the initial position. The plurality of images may include image data indicative of the first environment captured at the initial position (also referred to as “first image data”). The image determination module 420 may determine the first image data based on image data (also referred to as “second image data”) captured by each of the plurality of image capturing devices.

In some embodiments, each of the plurality of image capturing devices may be mounted on a fourth point of the target subject. The plurality of image capturing devices may respectively capture the second image data captured at fourth positions corresponding to the fourth points. As described above, the target point corresponding to the initial position may be the center of gravity of the target subject, the point where the positioning device is mounted on the target subject, the point where the image capturing device is mounted on the target subject, etc. Each of the fourth point may be different from the target point or the same as the target point. In some embodiments, if the target point is the same as one of the fourth point, the initial position of the target subject may be a position corresponding to the fourth point, and the image data from the fourth position may be the image data from the initial position. In some embodiments, if the target point is different from each of the fourth point, since the target point and the fourth point may be fixed on the target subject, a difference between the initial position corresponding to target point and a fourth position corresponding to the fourth point may be negligible and the first image data from the initial position and the second image data from the fourth position may be the same, the image determination module 420 may designate the image data from the fourth position as the image data from the initial position.

In a different application scenario, objects in the first environment may be different. Taking the vehicle running on the road as an example, there may be a road, a road block, a traffic sign, a barrier, a traffic line marking, a traffic light, a tree, a pedestrian, another vehicle, a building, etc., in the first environment.

In some embodiments, as described above, the plurality of image capturing devices may capture the image data from different views. For an image capturing device, the image capturing device may capture image data corresponding to a portion of the first environment. An image of the plurality of images may be generated based on the image data, i.e., the image may include the image data corresponding to the portion of the first environment. In some embodiments, the plurality of image capturing devices may be mounted according to a circle. For example, a count of the plurality of image capturing devices may be 6, each image capturing device may capture image data corresponding to ⅙ of the first environment, thereby capturing comprehensive image data of the first environment.

The first map determination module 430 may be configured to determine a first map based on the plurality of images. As used herein, the first map may include first map data indicative of the first environment associated with the initial position of the target subject. As described above, each of the plurality of images may include the image data corresponding to the portion of the first environment, the first map determination module 430 may determine the first map by combining the plurality of images. Besides, as described above, the image data of the each portion may be captured from different views (e.g., from the fourth positions corresponding to the fourth points where the plurality of image capturing devices are mounted and/or fixed), the first map determination module 430 may combine the plurality of images by transforming the plurality of images into a same view. Since the fourth points are fixed points of the target subject, the first map determination module 430 may convert the plurality of images (e.g., the image data) from the different views into the same view based on differences between each two of the fourth points.

In some embodiments, the first map determination module 430 may determine point clouds represented by the plurality of images respectively. The first map determination module 430 may determine the first map by transforming the point clouds into the same view based on the differences between each two of the fourth points. As used herein, the point cloud of an image may refer to a set of data points in a spatial space, and each data point may correspond to data of a point in the image. Merely by way of example, each data point may include location information of the point, color information of the point, intensity information of the point, texture information of the point, or the like, or any combination thereof. In some embodiments, the set of data points may represent feature information of the image. The feature information may include a contour of an object in the image, a surface of an object in the image, a size of an object in the image, or the like, or any combination thereof.

The second position determination module 440 may be configured to determine a target position of the target subject based on the initial position, the first map, and a second map in real-time. As used herein, the second map may include second map data indicative of a second environment corresponding to an area including the initial position of the target subject. For example, the area may include a district in a city, a region inside a beltway of a city, a town, a city, etc. In some embodiments, the second map may be predetermined by the positioning system 100 or a third party. The second positioning module 440 may obtain the second map from a storage device (e.g., the storage 150), such as the ones disclosed elsewhere in the present disclosure. In some embodiments, the second map may include a reference position corresponding to each point in the area. Similar to the initial point described elsewhere in the present disclosure, the reference position may include a reference location of the point and a reference attitude of the point.

In some embodiments, the second positioning module 440 may determine a match degree between map data of each position on a sub map of the second map and the map data of the first map (also referred to as “first map data” elsewhere in the present disclosure). In some embodiments, the sub map may include at least a portion of the second map corresponding to a sub area within the area. The match degree may indicate a similarity between the map data. The greater the similarity is, the greater the match degree may be. In some embodiments, the match degree may represent by a Normalised Information Distance (NID) or Mutual Information (MI). The greater the NID or the MI is, the larger the match degree may be.

In some embodiments, the second positioning module 440 may designate a position of the at least a portion of positions on the second map with a highest match degree as the target position. If the map data of the at least a portion of positions on the second map totally match the map data of the first map, the second positioning module 440 may consider that the target subject may be at the position on the second map.

The modules in the processing engine 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the first position determination module 410 and the second position determination module 460 may be combined as a single module which may both determine, via a positioning device, an initial position of a target subject in real-time and determine a target position of the target subject based on the initial position, a first map, and a second map in real-time. As another example, the processing engine 112 may include a storage module (not shown) which may be used to store data generated by the above-mentioned modules.

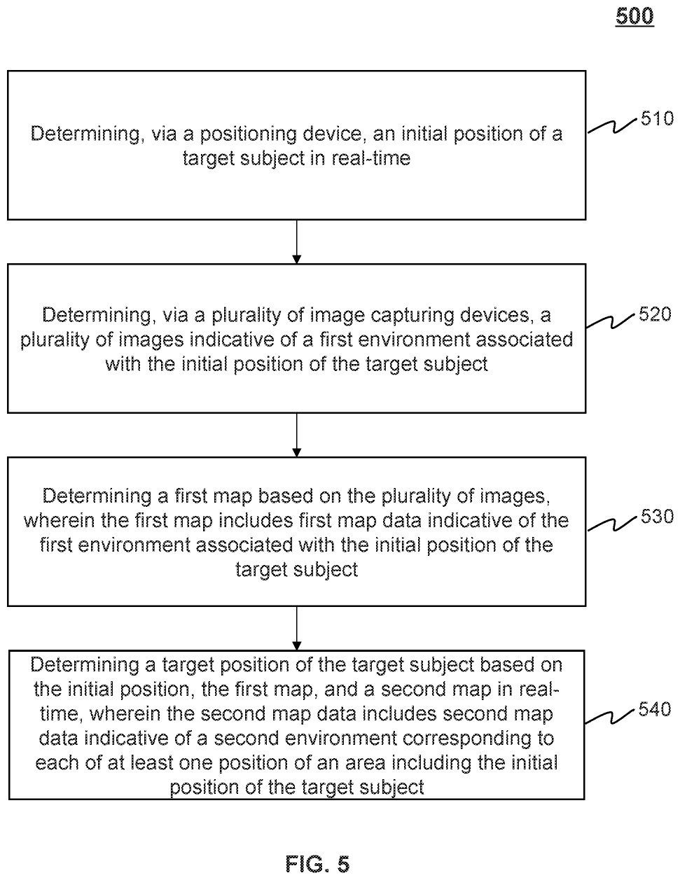

FIG. 5 is a flowchart illustrating an exemplary process for determining a target position of a target subject according to some embodiments of the present disclosure. In some embodiments, the process 500 may be implemented as a set of instructions (e.g., an application) stored in the ROM 230 or RAM 240. The processor 220 and/or the modules in FIG. 4 may execute the set of instructions, and when executing the instructions, the processor 220 and/or the modules may be configured to perform the process 500. The operations of the illustrated process presented below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, the processing engine 112 (e.g., the first position determination module 410 or the interface circuits of the processor 220) may determine, via a positioning device (e.g., the positioning device 140-1), an initial position of a target subject in real-time. As used herein, the target subject may be any subject that needs to be positioned. Merely by way of example, the target subject may include a manned vehicle, a semi-autonomous vehicle, an autonomous vehicle, a robot (e.g., a robot on road), etc. The vehicle may include a taxi, a private car, a hitch, a bus, a train, a bullet train, a high-speed rail, a subway, etc.

As used herein, the initial position of the target subject may refer to a position corresponding to a target point of the target subject. In some embodiments, the positioning system 100 may predetermine similar points (e.g., centers) as target points for different target subjects. In some embodiments, the positioning system 100 may predetermine different points as target points for different target subjects. Merely by way of example, the target point may include a center of gravity of the target subject, a point where a positioning device (e.g., the positioning device 140-1) is mounted on the target subject, a point where an image capturing device (e.g., the image capturing device 140-2) is mounted on the target subject, etc.

In some embodiments, as described in FIG. 1, the positioning device may be mounted and/or fixed on a first point of the target subject, and the positioning device may determine first position data of the first point. Further, the processing engine 112 may determine the initial position of the target subject based on the first positioning data. Specifically, since the first point and the target point are two fixed points of the target subject, the processing engine 112 may determine the initial position based on the first position, and a relationship associated with the target point and the first point. In some embodiments, the processing engine 112 may determine the initial position by converting the first position according to the relationship associated with the first point and the target point. Specifically, the processing engine 112 may determine a converting matrix based on the relation associated with the first point and the target point. The processing engine 112 may determine the converting matrix based on a translation associated with the first point and the target point and a rotation associated with the first point and the target point.

As used herein, the first positioning data may include a location corresponding to the first point and an attitude corresponding to the first point. The location may refer to an absolute location of a point (e.g., the first point) in a spatial space (e.g., the world) denoted by longitude and latitude information, and the absolute location may represent a geographic location of the point in the spatial space, i.e., longitude and latitude. The attitude may refer to an orientation of a point (e.g., the first point) with respect to an inertial frame of reference such as a horizontal plane, a vertical plane, a plane of a motion of the target subject or another entity such as nearby objects. The attitude corresponding to the first point may include a raw angle of the first point, a pitch angle of the first point, a roll angle of the first point, etc. Accordingly, the initial position of the target subject (i.e., the target point) may include an initial location of the target subject (i.e., the target point) and an initial attitude of the target subject (i.e., the target point). The initial location may refer to an absolute location of the target subject in the spatial space i.e., longitude and latitude. The initial attitude may refer to an orientation of the target subject with respect to an inertial frame of reference such as a horizontal plane, a vertical plane, a plane of a motion of the target subject or another entity such as nearby objects.

In some embodiments, the positioning device may include different types of positioning sensors. The different types of positioning sensors may be respectively mounted and/or fixed on a point of the target subject. In some embodiments, one or more positioning sensors may be integrated into the target subject. In some embodiments, the positioning device may include a first positioning sensor that can determine an absolute location of the target subject (e.g., a point of the subject) and a second positioning sensor that can determine an attitude of the target subject. Merely by way of example, the first positioning sensor may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. The second positioning sensor may include an Inertial Measurement Unit (IMU). In some embodiments, the IMU may include at least one motion sensor and at least one rotation sensor. The at least one motion sensor may determine a linear accelerated velocity of the subject, and the at least one rotation sensor may determine an angular velocity of the target subject. The IMU may determine the attitude of the subject based on the linear accelerated velocity and the angular velocity. For illustration purpose, the IMU may include a Platform Inertial Measurement Unit (PIMU), a Strapdown Inertial Measurement Unit (SIMU), etc.

For illustration purpose, the positioning device may include the GPS and the IMU (also referred to as “GPS/IMU”). In some embodiments, the GPS and/or the IMU may be integrated into the target object. In some embodiments, the GPS may be mounted and/or fixed on a second point of the target subject and the IMU may be mounted and/or fixed on a third point of the target subject. Accordingly, the GPS may determine a second location of the second point and the IMU may determine a third attitude of the third point. Since the third point and the second point are two fixed points of the target subject, the processing engine 112 may determine a third location of the third point based on a difference (e.g. a location difference) between the second point and the third point. Further, as described above, the processing engine 112 may determine the initial position by converting a position of the third point (i.e., the third attitude and the third location) according to the relation associated with the third point and the target point. Specifically, the processing engine 112 may determine a converting matrix based on the relation associated with the third point and the target point. The processing engine 112 may determine the converting matrix based on a translation associated with the third point and the target point and a rotation associated with the third point and the target point.

In 520, the processing engine 112 (e.g., the image determination module 420 or the interface circuits of the processor 220) may determine, via a plurality of image capturing devices, a plurality of images indicative of a first environment associated with the initial position of the target subject. As used herein, the first environment may refer to an environment where the target subject is captured at the initial position. The plurality of images may include image data indicative of the first environment captured at the initial position (also referred to as “first image data”). The processing engine 112 may determine the first image data based on image data (also referred to as “second image data”) captured by each of the plurality of image capturing devices.

In some embodiments, as described in connection with FIG. 1, each of the plurality of image capturing devices may be mounted on a fourth point of the target subject. The plurality of image capturing devices may respectively capture the second image data captured at fourth positions corresponding to the fourth points. As described above, the target point corresponding to the initial position may be the center of gravity of the target subject, the point where the positioning device is mounted on the target subject, the point where the image capturing device is mounted on the target subject, etc. Each of the fourth point may be different from the target point or the same as the target point. In some embodiments, if the target point is the same as one of the fourth point, the initial position of the target subject may be a position corresponding to the fourth point, and the image data from the fourth position may be the image data from the initial position. In some embodiments, if the target point is different from each of the fourth point, since the target point and the fourth point may be fixed on the target subject, a difference between the initial position corresponding to target point and a fourth position corresponding to the fourth point may be negligible and the first image data from the initial position and the second image data from the fourth position may be the same, the processing engine 112 may designate the image data from the fourth position as the image data from the initial position.

In a different application scenario, objects in the first environment may be different. Taking the vehicle running on the road as an example, there may be a road, a road block, a traffic sign, a barrier, a traffic line marking, a traffic light, a tree, a pedestrian, another vehicle, a building, etc., in the first environment.

In some embodiments, as described above, the plurality of image capturing devices may capture the image data from different views. For an image capturing device, the image capturing device may capture image data corresponding to a portion of the first environment. An image of the plurality of images may be generated based on the image data, i.e., the image may include the image data corresponding to the portion of the first environment. In some embodiments, the plurality of image capturing devices may be mounted according to a circle. For example, a count of the plurality of image capturing devices may be 6, each image capturing device may capture image data corresponding to ⅙ of the first environment, thereby capturing comprehensive image data of the first environment.

In some embodiments, the plurality of image capturing devices may include at least one depth camera, and the plurality of images may be depth images. The depth image may include distance information and pixel information of each point in the image. The distance information of a point may represent a distance of the point from a viewing point (e.g., a point from which the image is captured). The pixel information may represent a gray value of the point or an intensity of light received by the point. Each depth image may show a geometrical shape of each object in the image.

In 530, the processing engine 112 (e.g., the first map determination module 430 or the interface circuits of the processor 220) may determine a first map based on the plurality of images. As used herein, the first map may include first map data indicative of the first environment associated with the initial position of the target subject. As described above, each of the plurality of image may include the image data corresponding to the portion of the first environment, the processing engine 112 may determine the first map by combining the plurality of images. Besides, as described above, the image data of the each portion may be captured from different views (e.g., from the fourth positions corresponding to the fourth points where the plurality of image capturing devices are mounted are fixed), the processing engine 112 may combine the plurality of images by transforming the plurality of images into a same view. Since the fourth points are fixed points of the target subject, the processing engine 112 may convert the plurality of images (e.g., the image data) from the different views into the same view based on differences between each two of the fourth points.

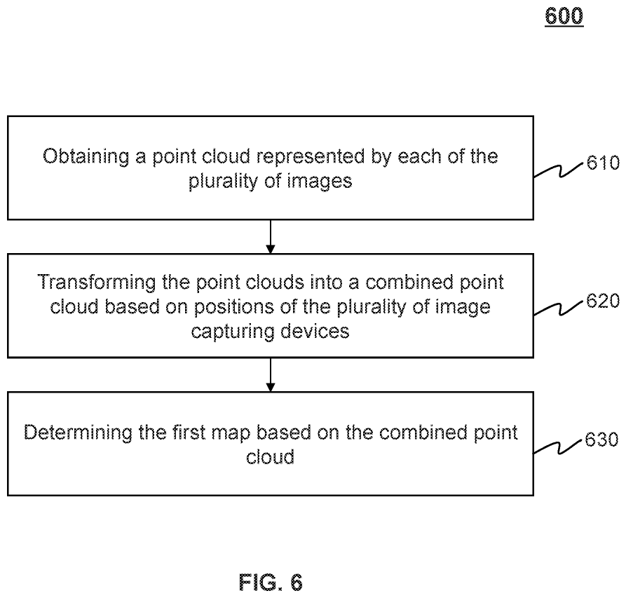

In some embodiments, the processing engine 112 may determine point clouds represented by the plurality of images respectively. The processing engine 112 may determine the first map by transforming the point clouds into the same view based on the differences between each two of the fourth points. As used herein, the point cloud of an image may refer to a set of data points in a spatial space, and each data point may correspond to data of a point in the image. Merely by way of example, each data point may include location information of the point, color information of the point, intensity information of the point, texture information of the point, or the like, or any combination thereof. In some embodiments, the set of data points may represent feature information of the image. The feature information may include a contour of an object in the image, a surface of an object in the image, a size of an object in the image, or the like, or any combination thereof. In some embodiments, the point cloud may be in a form of PLY, STL, OBJ, X3D, IGS, DXF, etc. More detailed description of determining the first map may be found elsewhere in the present disclosure, e.g., FIG. 6 and the description thereof.

In 540, the processing engine 112 (e.g., the first map determination module 440 or the interface circuits of the processor 220) may determine a target position of the target subject based on the initial position, the first map, and a second map in real-time. As used herein, the second map may include second map data indicative of a second environment corresponding to an area including the initial position of the target subject. For example, the area may include a district in a city, a region inside a beltway of a city, a town, a city, etc. In some embodiments, the second map may be predetermined by the positioning system 100 or a third party. The processing engine 112 may obtain the second map from a storage device (e.g., the storage 150), such as the ones disclosed elsewhere in the present disclosure.

In some embodiments, the second map may include a reference position corresponding to each point in the area. Similar to the initial point described elsewhere in the present disclosure, the reference position may include a reference location of the point and a reference attitude of the point. Since a positioning accuracy of the second map is more accurate than a positioning accuracy of the GPS/IMU, the processing engine 112 may determine a more accurate position (also referred to as “target position”) of the target subject by matching the first map and the second map based on the initial position. More detailed description of determining the target position of the target subject may be found elsewhere in the present disclosure. e.g., FIG. 0.7 and the description thereof.

In an application scenario, an autonomous vehicle may be positioned by the positioning system 100 in real-time. Further, the autonomous vehicle may be navigated by the positioning system 100.

In an application scenario, the positioning system 100 may transmit a message to a terminal (e.g., the terminal device 130), to direct the terminal to display the target position of the target subject e.g., on a user interface of the terminal in real-time, thereby facilitating the user to know where the target subject is in real-time.

In an application scenario, the positioning system 100 can determine a target position of the target subject in some places where the GPS signal is weak e.g., a tunnel. Further, the target position of the target subject can be used to provide a navigation service to the target subject.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional steps (e.g., a storing step) may be added elsewhere in the exemplary process 500. In the storing step, the processing engine 112 may store information (e.g., the initial position, the plurality of images, the first map, the second map) associated with the target subject in a storage device (e.g., the storage 150), such as the ones disclosed elsewhere in the present disclosure. As another example, if the plurality of images determined in operation 520 does not include a specific object, e.g., a traffic line marking, operation 530 and operation 540 may be omitted.

FIG. 6 is a flowchart illustrating an exemplary process for determining a first map based on a plurality of images according to some embodiments of the present disclosure. In some embodiments, the process 600 may be implemented as a set of instructions (e.g., an application) stored in the ROM 230 or RAM 240. The processor 220 and/or the modules in FIG. 4 may execute the set of instructions, and when executing the instructions, the processor 220 and/or the modules may be configured to perform the process 600. The operations of the illustrated process presented below are intended to be illustrative. In some embodiments, the process 600 may be accomplished with one or more additional operations not described and/or without one or more of the operations herein discussed. Additionally, the order in which the operations of the process as illustrated in FIG. 6 and described below is not intended to be limiting. In some embodiments, operation 530 of the process 500 may be implemented based on the process 600.

In 610, the processing engine 112 (e.g., the first map determination module 430 or the interface circuits of the processor 220) may obtain a point cloud represented by each of the plurality of images. As described in operation 530, the plurality of images may be depth images, and include distance information and pixel information of each point in the image. For an image of the plurality of images, the processing engine 112 may obtain a point cloud based on the distance information and the pixel information of each point in the image. Specifically, the processing engine 112 may first determine a coordinate system of the point cloud, e.g., based on a camera imaging model. The processing engine 112 may determine the point cloud by converting the distance information and the pixel information of each point in the image into the coordinate system of the point cloud. In some embodiments, each coordinate system of each point cloud of the plurality of images may be different or the same.

As described elsewhere in the present disclosure, the point cloud may refer to a set of data points in a spatial space (e.g., in the coordinate system of the point cloud), and each data point may correspond to data of a point in the image. Besides, each of the plurality of images may include the image data corresponding to the portion of the first environment, the point cloud of the image may include a set of data points corresponding to the portion of the first environment. Merely by way of example, each data point may include location information of the point, color information of the point, intensity information of the point, texture information of the point, or the like, or any combination thereof. In some embodiments, the set of data points may represent feature information of the image. The feature information may include a contour of an object in the image, a surface of an object in the image, a size of an object in the image, or the like, or any combination thereof.

In 620, the processing engine 112 (e.g., the first map determination module 430 or the interface circuits of the processor 220) may transform the point clouds into a combined point cloud based on positions of the plurality of image capturing devices. As described in operation 610, each of the point cloud of the image may include the set of data points corresponding to the portion of the first environment and each coordinate system of each point cloud of the plurality of images may be different or the same. The processing engine 112 may determine the combined point cloud by combining and/or converting the point clouds into a coordinate system of the combined point cloud. For each point cloud corresponding to an image, the processing engine 112 may transform each point in the point cloud into the coordinate system of the combined point cloud according to formula (1) below:

$$P = R \frac{z}{f} ( \begin{matrix}x - {c}_{x} \\ y - {c}_{y} \\ 1\end{matrix} ) + t \qquad ( 1 )$$

wherein P refers to the combined point cloud, R refers to a rotation angle of the point relative to the coordinate system of the combined point cloud, t refers to a translation value of the point relative to the coordinate system of the combined point cloud, f refers to a focus of an image capturing device capturing the image, (x, y) refers to a pixel coordinate of the point in the image in a pixel coordinate system, (cₓ, c_{y}) refers to a coordinate of a center in the image in the image pixel coordinate system, and z refers to depth information of the point. As used herein, the pixel coordinate may refer to a number that identifies a location of a pixel in the image pixel coordinate system. The origin of the image pixel coordinate system may be the top left corner of the top left pixel in the image, e.g., (0, 0).

In 630, the processing engine 112 (e.g., the first map determination module 430 or the interface circuits of the processor 220) may determine the first map based on the combined point cloud. In some embodiments, the processing engine 112 may project the combined point cloud in a horizontal plane, and determine the first map thereof.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

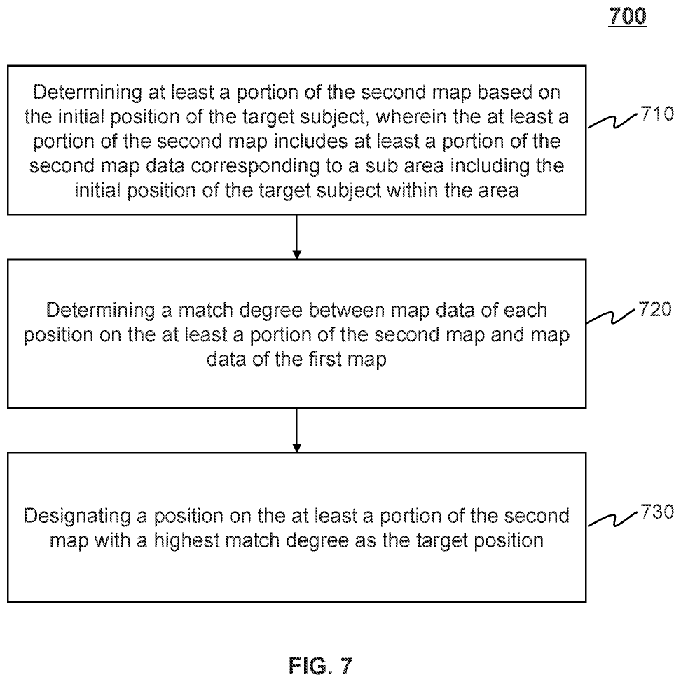

FIG. 7 is a flowchart illustrating an exemplary process for determining a target position of a target subject based on an initial position of the target subject, a first map and a second map according to some embodiments of the present disclosure. In some embodiments, the process 700 may be implemented as a set of instructions (e.g., an application) stored in the ROM 230 or RAM 240. The processor 220 and/or the modules in FIG. 4 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting. In some embodiments, operation 540 of the process 500 may be implemented based on the process 700.

In 710, the processing engine 112 (e.g., the second position determination module 440 or the interface circuits of the processor 220) may determine at least a portion of the second map based on the initial position of the target subject. The at least a portion of the second map (also referred to as “sub map”) may correspond to a sub area within the area. The sub area may include the initial position. As described in connection with operation 540, the second map may include the reference position corresponding to each point in the area. Accordingly, the sub map may include a reference position corresponding to each point in the sub area. In some embodiments, the sub area may be a circle centered at the initial position having a predetermined radius. The predetermined radius may be a default setting of the positioning system 100, or may be adjusted based on real-time conditions.

In 720, the processing engine 112 (e.g., the second position determination module 440 or the interface circuits of the processor 220) may determine a match degree between map data of each position on the sub map and the map data of the first map (also referred to as “first map data” elsewhere in the present disclosure). The match degree may indicate a similarity between the map data. The greater the similarity is, the greater the match degree may be. In some embodiments, the match degree may represent by a Normalised Information Distance (NID) or Mutual Information (MI). The greater the NID or the MI is, the larger the match degree may be. In some embodiments, for an NID or an MI between map data of a position on the sub map and the map data of the first map, the processing engine 112 may determine the NID based on Equation (2) or the MI based on Equation (3) below:

$$\begin{matrix}NID ( {I}_{r} , {I}_{s} ) = \frac{H ( {I}_{r} , {I}_{s} ) - MI ( {I}_{r} , {I}_{s} )}{H ( {I}_{r} , {I}_{s} )} & ( 2 ) \\ MI ( {I}_{r} , {I}_{s} ) = H ( {I}_{r} ) + H ( {I}_{s} ) - H ( {I}_{r} , {I}_{s} ) & ( 3 ) \\ H ( {I}_{s} ) = - {\sum }_{b = 1}^{n} {P}_{s} ( b ) log ( {P}_{s} ( b ) ) & ( 4 ) \\ H ( {I}_{r} ) = - {\sum }_{a = 1}^{n} {P}_{r} ( a ) log ( {P}_{r} ( a ) ) & ( 5 ) \\ H ( {I}_{r} , {I}_{s} ) = - {\sum }_{a = 1}^{n} {\sum }_{b = 1}^{n} {P}_{r , s} ( a , b ) {log P}_{r , s} ( a , b ) ) & ( 6 )\end{matrix}$$

wherein Iᵣ refers to the first map, Iₛ refers to the second map, NID(Iᵣ, Iₛ) refers to a NID between Iᵣ and Iₛ, H(Iᵣ, Iₛ) refers to a joint entropy of the Iᵣ and Iₛ, H(Iᵣ) refers to an entropy of the Iᵣ, and H(Iₛ) refers to an entropy of the Iₛ. As used herein, the processing engine 112 may determine H(Iₛ) based on Equation (4), wherein Pₛ refers to a discrete distribution of Iₛ represented by n-bin discrete histograms, and a refers to an individual bin indice associated with Iₛ. The processing engine 112 may determine H(Iᵣ) based on Equation (5), wherein Pᵣ refers to a discrete distribution of Iᵣ represented by n-bin discrete histograms, and a refers an individual bin index associated with Iᵣ. The processing engine 112 may determine H(Iᵣ, Iₛ) based on Equation (6), wherein P_{r,s}(a, b) refers to a joint discrete distribution of Iᵣ and Iₛ represented by n-bin discrete histograms.

In 730, the processing engine 112 (e.g., the second position determination module 440 or the interface circuits of the processor 220) may designate a position on the sub map with a highest match degree as the target position. If the map data of a position on the at least a portion of the second map totally match the map data of the first map, the processing engine 112 may consider that the target subject may be at the position on the second map.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining a target position of a target subject, comprising:
at least one storage medium including a set of instructions; and
at least one processor in communication with the at least one storage medium, wherein when executing the set of instructions, the at least one processor is directed to:
determine, via a positioning device, an initial position of a target subject in real-time;
determine, via a plurality of image capturing devices, a plurality of images indicative of a first environment associated with the initial position of the target subject;
determine a first map based on the plurality of images, wherein the first map includes first map data indicative of the first environment associated with the initial position of the target subject; and
determine a target position of the target subject based on the initial position, the first map, and a second map in real-time, wherein the second map is predetermined based on Lidar, and the second map includes second map data indicative of a second environment corresponding to an area including the initial position of the target subject.

2. The system of claim 1, wherein the positioning device includes a Global Positioning System (GPS) and an Inertial Measurement Unit (IMU).

3. The system of claim 2, wherein the GPS and the IMU are respectively mounted on the target subject.

4. The system of claim 2, wherein the initial position includes a location of the target subject and an attitude of the target subject.

5. The system of claim 1, wherein the plurality of image capturing devices include at least one depth camera.

6. The system of claim 5, wherein the at least one depth camera is respectively mounted on the target subject.

7. The system of claim 1, wherein to determine a first map based on the plurality of images, the at least one processor is directed to:
determine a first position of each of the plurality of image capturing devices; and
determine the first map by combining the plurality of images based on first positions of the plurality of image capturing devices.

8. The system of claim 7, wherein to determine the first map by combining the plurality of images based on first positions of the plurality of image capturing devices, the at least one processor is directed to:
obtain a point cloud represented by each of the plurality of images;
transform the point clouds into a combined point cloud based on the first positions of the plurality of image capturing devices; and
determine the first map based on the combined point cloud.

9. The system of claim 1, wherein to determine the target position of the target subject based on the initial position, the first map, and a second map in real-time, the at least one processor is directed to:
determine at least a portion of the second map based on the initial position of the target subject, wherein the at least a portion of the second map includes at least a portion of the second map data corresponding to a sub area including the initial position of the target subject within the area; and
determine the target position by comparing the first map data to the at least a portion of the second map data.

10. The system of claim 9, wherein to determine the target position by comparing the first map data to the at least a portion of the second map data, the at least one processor is directed to:
determine a match degree between map data of each position on the at least a portion of the second map and map data of the first map; and
designate a position on the at least a portion of the second map with a highest match degree as the target position.

11. The system of claim 10, wherein the match degree represents by a Normalised Information Distance (NID) or Mutual Information (MI).

12. The system of claim 1, wherein the target subject includes an autonomous vehicle, or a robot.

13. The system of claim 1, wherein the at least one processor is directed to:
transmit a message to a terminal for directing the terminal to display the target position of the target subject on a user interface of the terminal in real-time.

14. The system of claim 1, wherein the at least one processor is directed to:
provide a navigation service to the target subject based on the target position of the target subject in real-time.

15. A method implemented on a computing device having at least one processor, at least one storage medium, and a communication platform connected to a network, the method comprising:
determining, via a positioning device, an initial position of a target subject in real-time;
determining, via a plurality of image capturing devices, a plurality of images indicative of a first environment associated with the initial position of the target subject;
determining a first map based on the plurality of images, wherein the first map includes first map data indicative of the first environment associated with the initial position of the target subject; and
determining a target position of the target subject based on the initial position, the first map, and a second map in real-time, wherein the second map is predetermined based on Lidar, and the second map includes second map data indicative of a second environment corresponding to an area including the initial position of the target subject.

16-20. (canceled)

21. The method of claim 15, wherein the determining a first map based on the plurality of images includes:
determining a first position of each of the plurality of image capturing devices; and
determining the first map by combining the plurality of images based on first positions of the plurality of image capturing devices.

22. The method of claim 21, wherein the determining the first map by combining the plurality of images based on first positions of the plurality of image capturing devices includes:
obtaining a point cloud represented by each of the plurality of images;
transforming the point clouds into a combined point cloud based on the first positions of the plurality of image capturing devices; and
determining the first map based on the combined point cloud.

23. The method of claim 15, wherein the determining the target position of the target subject based on the initial position, the first map, and a second map in real-time includes:
determining at least a portion of the second map based on the initial position of the target subject, wherein the at least a portion of the second map includes at least a portion of the second map data corresponding to a sub area including the initial position of the target subject within the area; and
determining the target position by comparing the first map data to the at least a portion of the second map data.

24. The method of claim 23, wherein the determining the target position by comparing the first map data to the at least a portion of the second map data includes:
determining a match degree between map data of each position on the at least a portion of the second map and map data of the first map; and
designating a position on the at least a portion of the second map with a highest match degree as the target position.

25-28. (canceled)

29. A non-transitory computer readable medium, comprising executable instructions that, when executed by at least one processor, directs the at least one processor to perform a method, the method comprising:
determining, via a positioning device, an initial position of a target subject in real-time;
determining, via a plurality of image capturing devices, a plurality of images indicative of a first environment associated with the initial position of the target subject;
determining a first map based on the plurality of images, wherein the first map includes first map data indicative of the first environment associated with the initial position of the target subject; and
determining a target position of the target subject based on the initial position, the first map, and a second map in real-time, wherein the second map is predetermined based on Lidar, and the second map includes second map data indicative of a second environment corresponding to an area including the initial position of the target subject.
